(19) United States
(12) Patent Application Publication
(10) Pub. No.: US 2016/0178939 A1
(43) Pub. Date: Jun. 23, 2016

(54) Repairing Method for Dark Spots on Copper Interconnect COA LCD Panel and Structure of Copper Interconnect COA LCD Panel

(71) Applicant: Shenzhen China Star Optoelectronics Technology Co. Ltd., Shenzhen, Guangdong (CN)

(72) Inventors: Quan CHENG, Shenzhen, Guangdong (CN); Jiwang YUAN, Shenzhen, Guangdong (CN); Tao SUN, Shenzhen, Guangdong (CN)

(73) Assignee: Shenzhen China Star Optoelectronics Technology Co. Ltd., Shenzhen, Guangdong (CN)

(21) Appl. No.: 14/429,077

(22) PCT Filed: Feb. 9, 2015
(86) PCT No.: PCT/CN2015/072562

§ 371 Date: Mar. 18, 2015

(30) Foreign Application Priority Data
Dec. 18, 2014 (CN) 201410794836.3

(51) Int. Cl. G02F 1/13; G02F 1/1335; G02F 1/1343

(52) U.S. Cl. CPC G02F 1/1309; G02F 1/13439; G02F 1/133514

(57) ABSTRACT

A method of repairing dark spots on a COA LCD panel includes: providing a COA LCD panel having a substrate (11), a metal layer (12), a passivation layer (13), a color resistance layer (14), and a pixel electrode layer (15), the COA LCD panel including pixels, among which exist pixels of light spot defect, and via holes (41) through the color resistance layer, each via hole corresponding to one pixel; using laser from a side of the substrate (11) targeting at the via holes (41) corresponding to the defective pixel; controlling the laser to melt the metal layer (12) and welding the metal layer (12) with the pixel electrode layer (15); adjusting a relative potential and a pixel voltage of the pixel electrode layer (15) to be zero, so that a pixel area in the pixel electrode (15) layer shows as constant darkness, which finishes the repairing operation.

### BACKGROUND OF THE INVENTION

1. Field of the Invention

The present invention relates to display technology area, particularly to a repairing method for dark spots on a copper interconnect color filter on array (COA) liquid crystal display (LCD) panel and a structure of the copper interconnect COA LCD panel.

2. Description of the Prior Art

A liquid crystal display (LCD) panel comprises a color filter (CF), a thin film transistor (TFT) array substrate, and a liquid crystal layer between the two substrates. Transparent electrodes are set on the relative inner sides of the glass substrate and the TFT substrate. The LCD displays by on-and-off of optical paths with polarizers, where polarization of light is changed under the control over orientation of liquid crystal cells in the liquid crystal layer by electrical field.

During manufacturing process of the LCD panel, a spot defect on the LCD panel exists inevitably because of process error, pollution and so on. The spot defect generally can be light spot and dark spot. As depicted in FIG. 1, the conventional repairing method for dark spot is that it makes a metal layer 120 welded to a pixel electrode layer 150, so that the defective pixels are repaired as constant darkness.

As the LCD is developing to larger size, the industry needs a material with small wire resistance. The current mainstream material is aluminum alloy, whose resistance is 4˜5 μΩ·cm, and resistance of pure aluminum is 3˜3.5μΩ·cm. There is signal degradation in a panel over 50 inches in size because of longer wire. To prevent from signal degradation, it often uses driving ICs on two sides of the panel, which increases cost. Because the resistance of copper is only 2 μΩ·cm, the panel with the copper wire works with only a single driving integrate circuit (IC) on a side of the panel, which cuts off the cost of driving IC by half. There comes a copper interconnect technology applying to the LCD panel. The copper interconnect technology is applied to a color filter on array (COA) LCD, which makes a copper interconnect COA-LCD panel. But the dark spot repairing method mentioned above is not applicable to the copper interconnect COA LCD panel.

As depicted in FIG. 2, in the conventional repairing operation for dark spots on the copper interconnect COA LCD panel, because the CF is configured on the array substrate in the copper interconnect COA LCD panel, the metal layer 120 has to, drilling through a color resistance 140 of 3 um by thickness, be welded to the pixel electrode layer 150, which is inapplicable for laser. Also, as depicted in FIG. 3, a collapse can happen on the pixel electrode layer 150 on the TFT side, which causes short to the metal layer 120. It is not desirable. The place and direction of short is not under control.

Accordingly, it is necessary to propose a repairing method for dark spots on the copper interconnect COA LCD panel and a structure of the copper interconnect COA LCD panel applicable to the repairing method, which uplifts success rate of dark spot repair.

### SUMMARY OF THE INVENTION

The present invention aims to provide a repairing method for dark spots on a copper interconnect COA LCD panel, which facilitates repairing operation for dark spots on the copper interconnect COA LCD panel and uplifts the success rate of the dark spots repair.

The present invention also aims to provide a structure of copper interconnect COA LCD panel, which is so simple as to repair dark spots with laser.

According to the present invention, a method of repairing dark spots on a copper interconnect color filter on array (COA) liquid crystal display (LCD) panel, comprises:

Step 1: providing a copper interconnect COA LCD panel comprising a substrate, a metal layer configured on the substrate, a passivation layer configured on the metal layer, a color resistance layer configured on the passivation layer, and a pixel electrode layer configured on the color resistance layer, the copper interconnect COA LCD panel comprising a plurality of pixel, among which exist pixels of light spot defect, and a plurality of via holes through the color resistance layer, each via hole corresponding to one of the plurality of pixels;

Step 2: using laser from a side of the substrate targeting at the plurality of via holes corresponding to the defective pixel on the color resistance layer;

Step 3: controlling a volume of the laser so as to melt the metal layer and welding the metal layer, through the corresponding via hole, with the pixel electrode layer; and

Step 4: adjusting a relative potential of the pixel electrode layer to be zero, adjusting a corresponding pixel voltage in the pixel electrode layer to be zero, so that a corresponding pixel area in the pixel electrode layer shows as constant darkness, which finishes the repairing operation.

Furthermore, a common electrode is configured in the copper interconnect COA LCD panel, and the metal layer electrically connects to the common electrode.

Furthermore, a thickness of the metal layer is 0.3 um, a thickness of the passivation layer is 0.4 um, a thickness of the color resistance layer 14 is 3 um and a thickness of the pixel electrode layer 15 is 0.04 um.

Furthermore, the pixel electrode layer is made of indium tin oxide; the metal layer is made of copper or copper alloy.

According to the present invention, a copper interconnect COA LCD panel comprises: a substrate, a metal layer configured on the substrate, a passivation layer, a color resistance layer configured on the passivation layer configured on the metal layer, and a pixel electrode layer configured on the color resistance layer, wherein a plurality of pixel is configured in the copper interconnect COA LCD panel, and a plurality of via holes, corresponding to the pixels, is configured on the color resistance layer.

Furthermore, a common electrode is configured in the copper interconnect COA LCD panel, and the metal layer electrically connects to the common electrode.

Furthermore, a thickness of the metal layer is 0.3 um, a thickness of the passivation layer is 0.4 um, a thickness of the color resistance layer 14 is 3 um and a thickness of the pixel electrode layer 15 is 0.04 um.

Furthermore, the pixel electrode layer is made of indium tin oxide; the metal layer is made of copper or copper alloy.

According to the present invention, a method of repairing dark spots on a copper interconnect color filter on array (COA) liquid crystal display (LCD) panel, comprises:

Step 1: providing a copper interconnect COA LCD panel comprising a substrate, a metal layer configured on the substrate, a passivation layer configured on the metal layer, a color resistance layer configured on the passivation layer, and a pixel electrode layer configured on the color resistance layer, the copper interconnect COA LCD panel comprising a plurality of pixel, among which exist pixels of light spot defect, and a plurality of via holes through the color resistance layer, each via hole corresponding to one of the plurality of pixels;

Step 2: using laser from a side of the substrate targeting at the plurality of via holes corresponding to the defective pixel on the color resistance layer;

Step 3: controlling a volume of the laser so as to melt the metal layer and welding the metal layer, through the corresponding via hole, with the pixel electrode layer; and

Step 4: adjusting a relative potential of the pixel electrode layer to be zero, adjusting a corresponding pixel voltage in the pixel electrode layer to be zero, so that a corresponding pixel area in the pixel electrode layer shows as constant darkness, which finishes the repairing operation;

wherein a common electrode is configured in the copper interconnect COA LCD panel, and the metal layer electrically connects to the common electrode;

wherein a thickness of the metal layer is 0.3 um, a thickness of the passivation layer is 0.4 um, a thickness of the color resistance layer 14 is 3 um and a thickness of the pixel electrode layer 15 is 0.04 um.

The beneficiary effect of the present invention is that the repairing method according to the present invention is simple for operation so as to effectively raise the success rate of repair, whereby the via holes corresponding to the pixels are configured over the color resistance layer. During the repairing operation, the laser does not have to drill through the color resistance layer. The laser, under volume control, melts the metal layer and makes the metal layer, through the via hole of the color resistance layer, welded to the pixel electrode layer. As a result, the relative potential of the pixel electrode later turns to be zero, the corresponding pixel voltage in the pixel electrode layer becomes zero, and then a corresponding pixel area in the pixel electrode layer shows as constant darkness mode. Regarding the structure of the copper interconnect COA LCD panel, it is a simple structure of the copper interconnect COA LCD panel that the via holes corresponding to the pixels are configured over the color resistance layer. During the repairing operation, the laser does not have to drill through the color resistance layer, which is easier for using laser and then decrease the production cost.

### BRIEF DESCRIPTION OF THE DRAWINGS

The accompanying drawings are included to provide a further understanding of the invention, and are incorporated in and constitute a part of this specification.

FIG. 1 shows a diagram of a conventional repairing method for dark spots on an LCD panel.

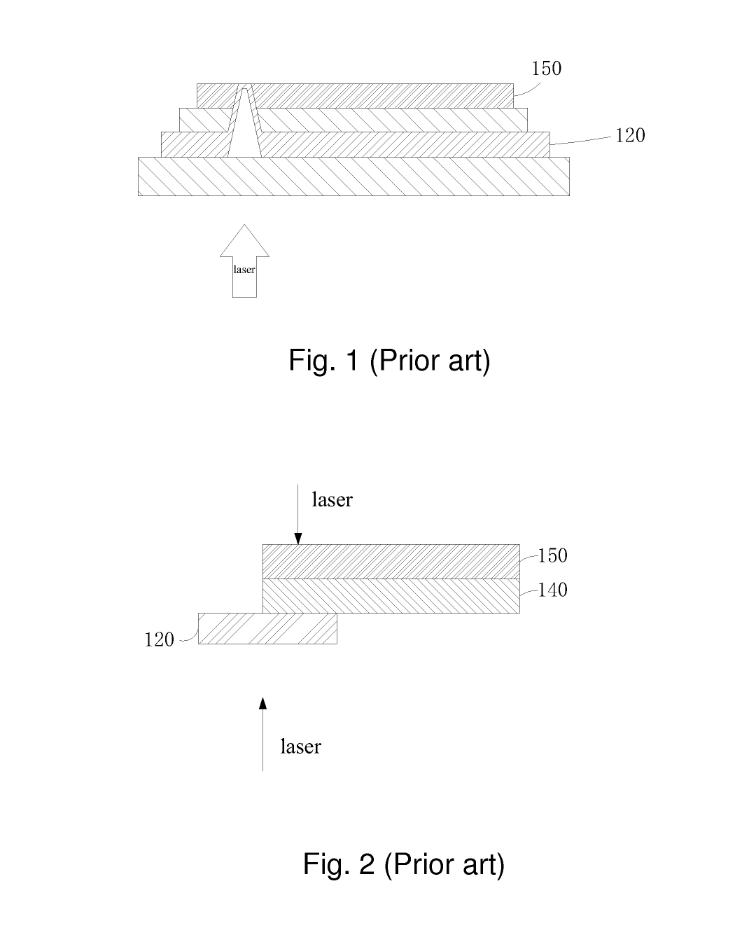

FIGS. 2 and 3 show diagrams of a conventional repairing method for dark spots on a copper interconnect COA LCD panel.

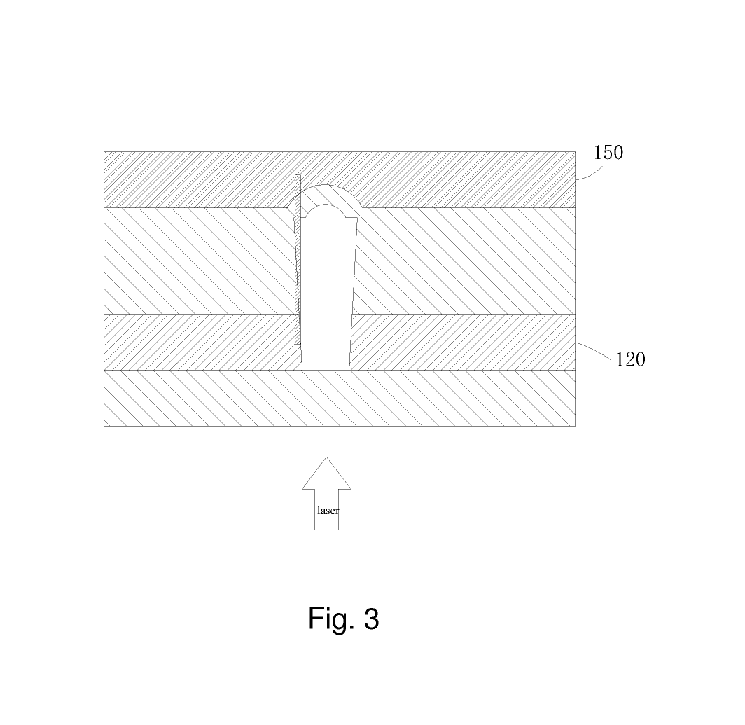

FIG. 4 is a flowchart of a repairing method for dark spots on a copper interconnect COA LCD panel according to a preferred embodiment of the present invention.

FIG. 5 shows a schematic diagram of a copper interconnect COA LCD panel according to a preferred embodiment of the present invention.

### DETAILED DESCRIPTION OF THE PREFERRED EMBODIMENTS

The drawings illustrate embodiments of the invention and, together with the description, serve to explain the principles of the invention.

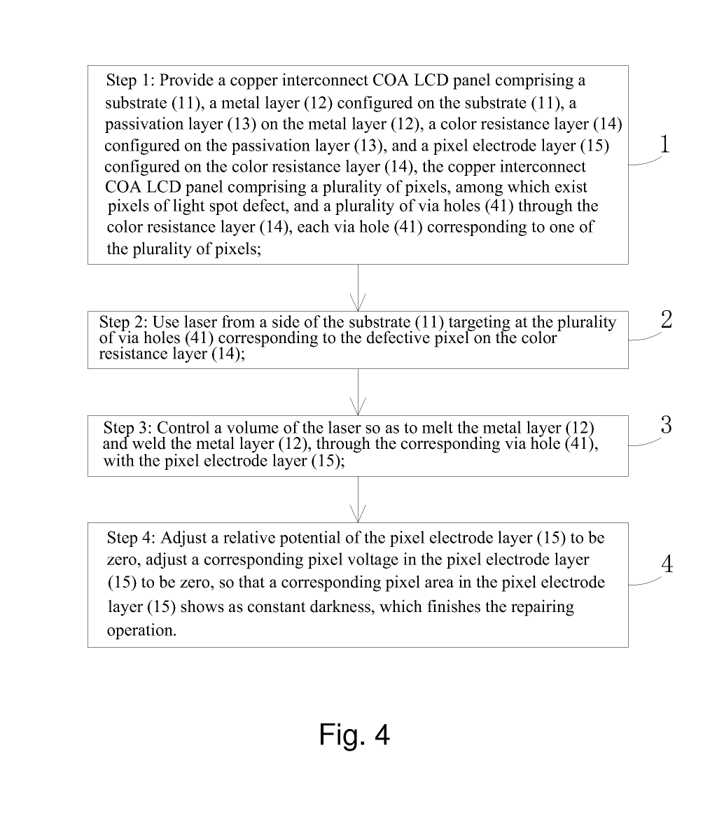

Referring to FIG. 4, the present invention, providing a repairing method for dark spots on a copper interconnect COA LCD panel, comprises the following steps:

Step 1: provide a copper interconnect COA LCD panel, comprising a substrate 11, a metal layer 12 configured on the substrate 11, a passivation layer 13 configured on the metal layer 11, a color resistance layer 14 configured on the passivation layer 13, and a pixel electrode layer 15 configured on the color resistance layer 14. There is a plurality of pixel on the copper interconnect COA LCD panel, among which exist pixels of light spot defect. A plurality of via holes 41, corresponding to each pixel, is configured on the color resistance layer 14.

In detail, wires for each device on the substrate 11 of the copper interconnect COA LCD panel are made of copper. The metal layer 12 is made of copper or copper alloy.

Furthermore, a common electrode is configured in the copper interconnect COA LCD panel. The metal layer 12 electrically connects to the common electrode. The common electrode and the pixel electrode layer 15 on the substrate 11 create an electric field between the two, whereby the movement of liquid crystal cells in a liquid crystal layer is under control.

Preferably, a thickness of the metal layer 12 is 0.3 um. A thickness of the passivation layer 14 is 0.4 um. That of the color resistance layer 14 is 3 um. A thickness of the pixel electrode layer 15 is 0.04 um.

Preferably, the pixel electrode layer 15 is made of indium tin oxide.

Preferably, the substrate 11 is a glass substrate.

Step 2: use laser from the side of substrate 11 targeting at the via hole 41 corresponding to the defective pixel on the color resistance layer 14.

Step 3: control the volume of the laser so as to melt the metal layer 12 and make the metal layer, through the via hole 41, welded to the pixel electrode layer 15.

Step 4: the relative potential of the pixel electrode layer 15 turns to be zero, the corresponding pixel voltage in the pixel electrode layer 15 becomes zero, and then a corresponding pixel area in the pixel electrode layer 15 shows as constant darkness. Repairing the dark spot on the copper interconnect COA LCD panel is done.

According to the repairing method mentioned above, the via holes corresponding to the pixels are configured over the color resistance layer. During the repairing operation, the laser does not have to drill through the color resistance layer. The laser, under volume control, melts the metal layer and makes the metal layer, through the corresponding via hole of the color resistance layer, welded to the pixel electrode layer. As a result, the relative potential of the pixel electrode later turns to be zero, the corresponding pixel voltage in the pixel electrode layer becomes zero, and then a corresponding pixel area in the pixel electrode layer shows as constant darkness. It is easy to operate the repairing method for dark spots on the copper interconnect COA LCD panel. The method also effectively raises the success rate of repair.

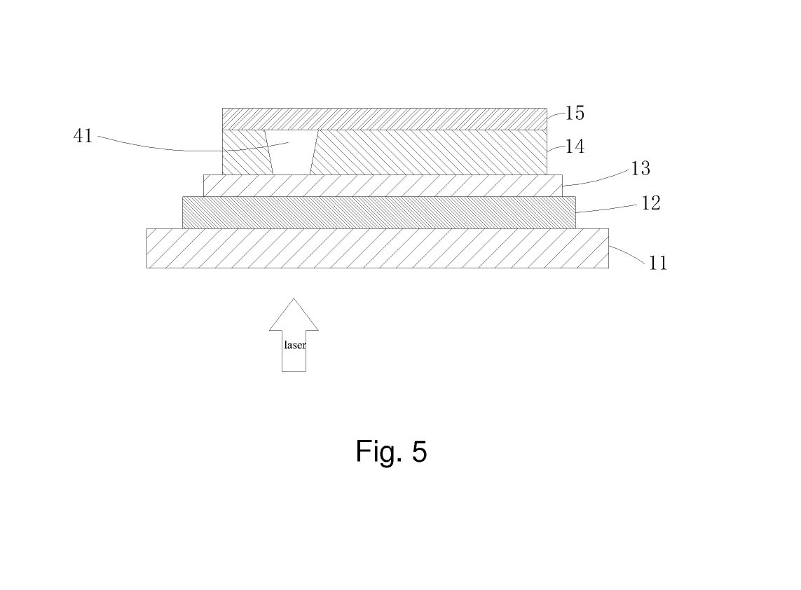

As depicted in FIG. 5, the present invention also provides a structure of copper interconnect COA LCD panel comprising the substrate 11, the metal layer 12 configured on the substrate 11, the passivation layer 13, the color resistance layer 14 configured on the passivation layer 13, and the pixel electrode layer 15 configured on the color resistance layer 14. There is the plurality of pixel in the copper interconnect COA LCD panel. The plurality of via holes 41, each via hole 41 corresponding to one of the pixels, are configured on the color resistance layer 14.

In detail, wires for each device on the substrate 11 of the copper interconnect COA LCD panel are made of copper. The metal layer 12 is made of copper or copper alloy.

Furthermore, a common electrode is configured in the copper interconnect COA LCD panel. The metal layer 12 electrically connects to the common electrode. The common electrode and the pixel electrode layer 15 on the substrate 11 create an electric field between the two, whereby the movement of liquid crystal cells in a liquid crystal layer is under control.

Preferably, a thickness of the metal layer 12 is 0.3 um. A thickness of the passivation layer 14 is 0.4 um. A thickness of the color resistance layer 14 is 3 um. A thickness of the pixel electrode layer 15 is 0.04 um.

Preferably, the substrate 11 is a glass substrate.

Preferably, the pixel electrode layer 15 is made of indium tin oxide.

It is a simple structure of the copper interconnect COA LCD panel that the via holes corresponding to the pixels are configured over the color resistance layer. During the repairing operation, the laser does not have to drill through the color resistance layer, which is easier for using laser and then decrease the production cost.

In sum, the repairing method according to the present invention is simple for operation so as to effectively raise the success rate of repair, whereby the via holes corresponding to the pixels are configured over the color resistance layer. During the repairing operation, the laser does not have to drill through the color resistance layer. The laser, under volume control, melts the metal layer and makes the metal layer, through the via hole of the color resistance layer, welded to the pixel electrode layer. As a result, the relative potential of the pixel electrode later turns to be zero, the corresponding pixel voltage in the pixel electrode layer becomes zero, and then a corresponding pixel area in the pixel electrode layer shows as constant darkness mode. Regarding the structure of the copper interconnect COA LCD panel, it is a simple structure of the copper interconnect COA LCD panel that the via holes corresponding to the pixels are configured over the color resistance layer. During the repairing operation, the laser does not have to drill through the color resistance layer, which is easier for using laser and then decrease the production cost.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A method of repairing dark spots on a copper interconnect color filter on array (COA) liquid crystal display (LCD) panel, comprising:
Step 1: providing a copper interconnect COA LCD panel comprising a substrate, a metal layer configured on the substrate, a passivation layer configured on the metal layer, a color resistance layer configured on the passivation layer, and a pixel electrode layer configured on the color resistance layer, the copper interconnect COA LCD panel comprising a plurality of pixels, among which exist a defective pixel of light spot defect, and a plurality of via holes through the color resistance layer, each via hole corresponding to one of the plurality of pixels;
Step 2: using laser from a side of the substrate targeting at the plurality of via holes corresponding to the defective pixel on the color resistance layer;
Step 3: controlling a volume of the laser so as to melt the metal layer and welding the metal layer, through the corresponding via hole, with the pixel electrode layer; and
Step 4: adjusting a relative potential of the pixel electrode layer to be zero, adjusting a corresponding pixel voltage in the pixel electrode layer to be zero, so that a corresponding pixel area in the pixel electrode layer shows as constant darkness, which finishes the repairing operation.

2. The method of claim 1, wherein a common electrode is configured in the copper interconnect COA LCD panel, and the metal layer electrically connects to the common electrode.

3. The method of claim 1, wherein a thickness of the metal layer is 0.3 um, a thickness of the passivation layer is 0.4 um, a thickness of the color resistance layer 14 is 3 um and a thickness of the pixel electrode layer 15 is 0.04 um.

4. The method of claim 1, wherein the pixel electrode layer is made of indium tin oxide.

5. The method of claim 1, wherein the metal layer is made of copper or copper alloy.

6. A copper interconnect COA LCD panel comprising: a substrate, a metal layer configured on the substrate, a passivation layer configured on the metal layer, a color resistance layer configured on the passivation layer, and a pixel electrode layer configured on the color resistance layer, wherein a plurality of pixels are configured in the copper interconnect COA LCD panel, and a plurality of via holes, corresponding to the pixels, is configured on the color resistance layer.

7. The copper interconnect COA LCD panel of claim 6, wherein a common electrode is configured in the copper interconnect COA LCD panel, and the metal layer electrically connects to the common electrode.

8. The copper interconnect COA LCD panel of claim 6, wherein a thickness of the metal layer is 0.3 um, a thickness of the passivation layer is 0.4 um, a thickness of the color resistance layer 14 is 3 um and a thickness of the pixel electrode layer 15 is 0.04 um.

9. The copper interconnect COA LCD panel of claim 6, wherein the pixel electrode layer is made of indium tin oxide.

10. The copper interconnect COA LCD panel of claim 6, wherein the metal layer is made of copper or copper alloy.

11. A method of repairing dark spots on a copper interconnect color filter on array (COA) liquid crystal display (LCD) panel, comprising:
Step 1: providing a copper interconnect COA LCD panel comprising a substrate, a metal layer configured on the substrate, a passivation layer configured on the metal layer, a color resistance layer configured on the passivation layer, and a pixel electrode layer configured on the color resistance layer, the copper interconnect COA LCD panel comprising a plurality of pixels, among which exist a defective pixel of light spot defect, and a plurality of via holes through the color resistance layer, each via hole corresponding to one of the plurality of pixels;
Step 2: using laser from a side of the substrate targeting at the plurality of via holes corresponding to the defective pixel on the color resistance layer;
Step 3: controlling a volume of the laser so as to melt the metal layer and welding the metal layer, through the corresponding via hole, with the pixel electrode layer; and
Step 4: adjusting a relative potential of the pixel electrode layer to be zero, adjusting a corresponding pixel voltage in the pixel electrode layer to be zero, so that a corresponding pixel area in the pixel electrode layer shows as constant darkness, which finishes the repairing operation;
wherein a common electrode is configured in the copper interconnect COA LCD panel, and the metal layer electrically connects to the common electrode;
wherein a thickness of the metal layer is 0.3 um, a thickness of the passivation layer is 0.4 um, a thickness of the color resistance layer 14 is 3 um and a thickness of the pixel electrode layer 15 is 0.04 um.

12. The method of claim 11, wherein the pixel electrode layer is made of indium tin oxide.

13. The method of claim 11, wherein the metal layer is made of copper or copper alloy.
